(19) United States
(12) Patent Application Publication
(10) Pub. No.: US 2026/0160355 A1
(43) Pub. Date: Jun. 11, 2026

(54) MAGNETIC CONTROLLED VALVE WITH ADJUSTABLE SEALING REGION

(71) Applicant: Alcon Inc., Fribourg (CH)

(72) Inventors: Brian C. Patterson, Burleson, TX (US); Monica Jane Crary, Fort Worth, TX (US); Reed Allen Pifer, Willow Park, TX (US); Stephen Paul Shannon, Arlington, TX (US); Allison Renee Campolo, Euless, TX (US)

(21) Appl. No.: 19/411,924

(22) Filed: Dec. 8, 2025

Related U.S. Application Data
(60) Provisional application No. 63/729,708, filed on Dec. 9, 2024.

(51) Int. Cl. F16K 31/08; B65D 47/30

(52) U.S. Cl. CPC F16K 31/084; B65D 47/30

(57) ABSTRACT

In some embodiments, a dispensing plug includes a fluid path having an inlet and an outlet. The dispensing plug also includes a valve adjustably disposed relative to the fluid path. The valve includes a first valve portion positioned in the fluid path between the inlet and the outlet. The valve also includes a second valve portion oriented to cause a first force to be exerted on the first valve portion. The first force biases the first valve portion toward closure of the fluid path.

### INTRODUCTION

This application claims the benefits under 35 USC § 119 (e) of U.S. provisional application No. 63/729,708, filed on 9 Dec. 2024, incorporated by reference in its entirety.

Many pathologies of the eye are treated by direct application of fluids to the eye, such as liquid eye drops. For example, conjunctivitis is treated by directly applying eye drops containing antibiotics. Dry eyes and glaucoma are also treated using eye drops. In general, eye drops and other treatment fluids can be used as lubricants for relieving discomfort and dryness of the eyes, as well as delivery vehicles for therapeutic substances.

Eye drops, as well as other treatment fluids, are typically stored in flexible containers. To apply a treatment fluid to a patient's eye, the flexible container is manually compressed by a user to dispense the treatment fluid through a nozzle or other opening in the flexible container. However, there is a risk of microbial ingress to the container.

### SUMMARY

In some embodiments, a dispensing plug valve includes an base at a first end. The dispensing plug valve includes a tapered body coupled to the base, wherein the tapered body defines a tapered volume. The dispensing plug valve includes a valve tip disposed at a second end. The dispensing plug valve includes a retention region disposed between the tapered body and the valve tip. The dispensing plug valve includes a magnet system disposed proximate to the valve tip in the retention region, the magnet system includes a first magnet and a second magnet on opposite sides of the retention region. The dispensing plug valve includes a fluid path defined between the tapered volume and the valve tip within the retention region, wherein fluid exits the valve tip through the fluid path in response to a pressure within the tapered volume overcoming a magnetic biasing force, and wherein fluid is prevented from entering the tapered volume through the fluid path when the pressure within the tapered volume does not overcome the magnetic biasing force.

In some embodiments, a system includes a flexible container. The system includes a dispensing plug compression- or friction-fit inside an opening of the flexible container. The dispensing plug includes a dispensing plug distal portion. The dispensing plug includes a dispensing plug proximal portion. The dispensing plug includes a dispensing plug valve disposed between the dispensing plug distal portion and the dispensing plug proximal portion. The dispensing plug valve includes an base at a first end. The dispensing plug valve includes a tapered body coupled to the base, wherein the tapered body defines a tapered volume. The dispensing plug valve includes a valve tip disposed at a second end. The dispensing plug valve includes a retention region disposed between the tapered body and the valve tip. The dispensing plug valve includes a magnet system disposed proximate to the valve tip and retained in the retention region, the magnet system including a first magnet and a second magnet on opposite sides of the retention region. The dispensing plug valve includes a fluid path defined between the tapered volume and the valve tip within the retention region, wherein fluid exits the valve tip through the fluid path in response to exerting a pressure on an outer surface of a body of the flexible container to overcome a magnetic biasing force of the magnet system, and wherein fluid is prevented from entering the tapered volume through the fluid path when the pressure exerted on the outer surface of the body of the flexible container does not overcome the magnetic biasing force.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is an exploded view of a system that may be utilized for dispensing fluids, according to some embodiments of the present disclosure.

FIG. 2A is an exploded view of a dispensing plug including a dispensing plug distal portion, a dispensing plug valve, and a dispensing plug proximal portion, according to some embodiments of the present disclosure.

FIG. 2B is an exploded, cross-sectional view of the dispensing plug at cross-section 2-2, according to some embodiments of the present disclosure.

FIG. 2C is a cross-sectional view of the dispensing plug, according to some embodiments of the present disclosure.

FIG. 3A is a perspective view of the dispensing plug valve, according to some embodiments of the present disclosure.

FIG. 3B is a side view of the dispensing plug valve, according to some embodiments of the present disclosure.

FIG. 3C is a cross-sectional view of the dispensing plug valve at a cut line 3C-3C, according to some embodiments of the present disclosure.

FIG. 3D is a cross-sectional view of the dispensing plug valve at a cut line 3D-3D, according to some embodiments of the present disclosure.

FIG. 3E is a bottom view of the dispensing plug, according to some embodiments of the present disclosure.

FIG. 4A is a schematic, cross-sectional view of an example dispensing plug valve with a magnet system in a closed state, according to some embodiments of the present disclosure.

FIG. 4B is a schematic, cross-sectional side view of the example dispensing plug valve with a magnet system of FIG. 4A in an open state, according to some embodiments of the present disclosure.

FIG. 5A is a perspective of an example dispensing plug distal portion, according to some embodiments of the present disclosure.

FIG. 5B is a side view of the dispensing plug distal portion, according to some embodiments of the present disclosure.

FIG. 5C is a cross-sectional view of the dispensing plug distal portion, according to some embodiments of the present disclosure.

FIG. 5D is a cross-sectional view of the tip, according to some embodiments of the present disclosure.

FIG. 5E is a top view of the dispensing plug distal portion, according to some embodiments of the present disclosure.

FIG. 5F is a bottom view of the dispensing plug distal portion, according to some embodiments of the present disclosure.

FIG. 6A is a perspective of a second example dispensing plug distal portion, according to some embodiments of the present disclosure.

FIG. 6B is a side view of the second dispensing plug distal portion, according to some embodiments of the present disclosure.

FIG. 6C is a cross-sectional view of the second dispensing plug distal portion, according to some embodiments of the present disclosure.

FIG. 6D is a cross-sectional view of a tip, according to some embodiments of the present disclosure.

FIG. 6E is a top view of the second dispensing plug distal portion, according to some embodiments of the present disclosure.

FIG. 6F is a bottom view of the second dispensing plug distal portion, according to some embodiments of the present disclosure.

FIG. 7A is a perspective of a third example dispensing plug distal portion, according to some embodiments of the present disclosure.

FIG. 7B is a top view of the third dispensing plug distal portion, according to some embodiments of the present disclosure.

FIG. 7C is a side view of the third dispensing plug distal portion, according to some embodiments of the present disclosure.

FIG. 7D is a cross-sectional view of the third dispensing plug distal portion, according to some embodiments of the present disclosure.

FIG. 7E is a cross-sectional view of a tip, according to some embodiments of the present disclosure.

FIG. 7F is a bottom view of the third dispensing plug distal portion, according to some embodiments of the present disclosure.

FIG. 8A is a perspective of an example dispensing plug proximal portion, according to some embodiments of the present disclosure.

FIG. 8B is a side view of the dispensing plug proximal portion.

FIG. 8C is a cross-sectional view of the dispensing plug proximal portion.

FIG. 8D is a top view of the dispensing plug proximal portion, according to some embodiments of the present disclosure.

FIG. 8E is a bottom view of the dispensing plug proximal portion, according to some embodiments of the present disclosure.

FIG. 9A is a perspective of a second example dispensing plug proximal portion, according to some embodiments of the present disclosure.

FIG. 9B is a top view of the second dispensing plug proximal portion, according to some embodiments of the present disclosure.

FIG. 9C is a side of the second dispensing plug proximal portion, according to some embodiments of the present disclosure.

FIG. 9D is a cross-sectional view of the second dispensing plug proximal portion, according to some embodiments of the present disclosure.

FIG. 9E is a bottom view of the second dispensing plug proximal portion, according to some embodiments of the present disclosure.

FIG. 10A is a perspective of a third example dispensing plug proximal portion, according to some embodiments of the present disclosure.

FIG. 10B is a top view of the third dispensing plug proximal portion, according to some embodiments of the present disclosure.

FIG. 10C is a side view of the third dispensing plug proximal portion, according to some embodiments of the present disclosure.

FIG. 10D is a cross-sectional view of the third dispensing plug proximal portion, according to some embodiments of the present disclosure.

FIG. 10E is a bottom view of the third dispensing plug proximal portion, according to some embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure provide an apparatus for dispensing fluids (including gels, emulsions, suspensions, and the like) from flexible containers, while providing improved prevention of microbial ingress into the containers. Examples of flexible containers include eye drop dispensers, droptainers, drop bottles, squeeze bottles, dropping bottles, squeeze tubes, and the like. To actuate the dispensing of fluids contained within a flexible container, portions of a body of the flexible container may be compressed or squeezed by a user. This manual compression increases the pressure within the flexible container and/or compresses the fluids therein, thereby causing the fluids to be expelled through an opening, or outlet, of the flexible container, such as a nozzle.

Examples will now be described relative to the Drawings.

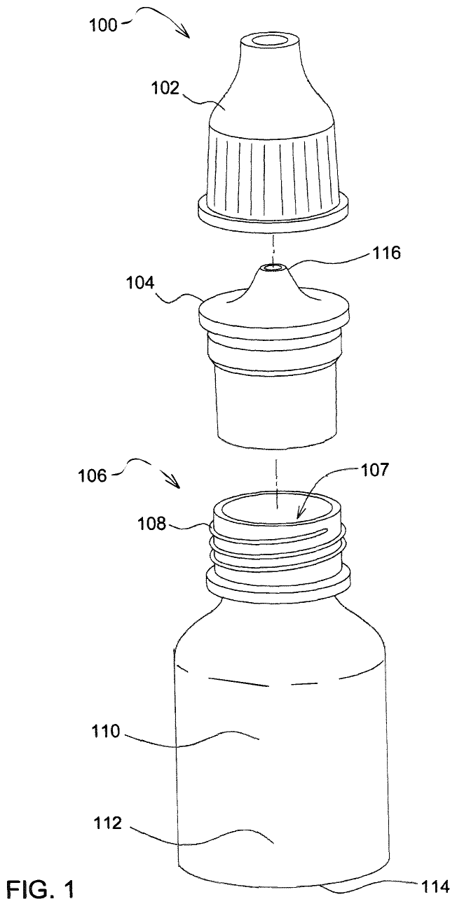

FIG. 1 is an exploded view of a system 100 that may be utilized for dispensing fluids. The system 100 includes a cap or nozzle 102, a dispensing plug 104, and a flexible container 106. The flexible container may be a “squeezable container”, which refers to a container with flexible walls that can be easily squeezed or compressed when pressure force(s) are applied on the outside wall of the flexible container 106. Thereby, the flexible container 106 is deformable and changes, at least temporarily, its original shape.

The flexible container 106 may be, for example, a bottle or droptainer. In the description herein, “proximal” with reference to the flexible container 106 shall be understood as the end of the flexible container 106 including a base opposite of a dispensing end of the flexible container 106. “Distal” with reference to the flexible container 106 shall be understood as the end of the flexible container 106 from which fluids contained in the flexible container 106 are dispensed.

In the illustrated embodiment, the flexible container 106 includes a body 110 having a tubular or cylindrical shape extending between an opening 107 at a dispensing end 108 and a proximal end 112 having an annular base 114. It should be appreciated that the shape shown relative to the body 110 is merely illustrative. In various embodiments, the body 110 can have any suitable geometry, shape, and/or size including, for example, tapered shapes, ovaloid shapes, and/or the like.

In the illustrated embodiment, fluid from the flexible container 106 can be transmitted from the opening 107 at the dispensing end 108, into the dispensing plug 104, by applying compression force(s) against the outer surface of the body 110 of the flexible container 106, which may then increase the fluid pressure within the flexible container 106, to force fluids out of a tip 116 of the dispensing plug 104.

In general, the dispensing plug 104 is placed within an opening 107 of the flexible container 106 such that the opening 107 is sealed airtight by the dispensing plug 104. For example, in some embodiments, the dispensing plug 104 is compression- or friction-fit inside the opening 107 of the flexible container 106. In these embodiments, the cap 102 can be attached to the dispensing plug 104 instead of, or in addition to, the flexible container 106.

The cap or nozzle 102 may be placed over the dispensing plug 104 and attached or fastened, for example, to the dispensing end 108 of the flexible container 106. In some embodiments, the system 100 includes the cap 102. The cap 102 can be attached to the flexible container 106 to seal the system 100 for storage, for example, between uses, or for long-term storage. The cap 102 can be placed over the dispensing plug 104 to seal off, or block, a tip 116 of the dispensing plug 104 from the external environment, thereby obstructing or preventing microbes or other contaminants from entering the system 100 during storage, as well as preventing fluids from unintentionally spilling out of system 100.

In some embodiments, the cap 102 is configured to secure onto the flexible container 106 or the dispensing plug 104 via a threaded connection. In such embodiments, an inner surface of the cap 102 can include one or more threads or grooves disposed on an inner surface thereof and configured to mate with one or more threads or grooves of the dispensing end 108 disposed on an outer surface of the flexible container 106. In other embodiments, however, the cap 102 can be secured onto the flexible container 106 or the dispensing plug 104 via a snap fit, friction fit, clasp, or the like.

In some embodiments, the cap 102 includes an additional plug. The additional plug can be configured to slide into the tip 116 of the dispensing plug 104 and function as a stopper to further prevent contaminants from entering the system 100, and/or to prevent the fluid from unintentionally spilling out. Further, the additional plug can function to reduce a volume of fluid contained in the dispensing plug 104 during storage by filling at least some of the space in the channel of the dispensing plug 104 through which the fluids are passed, which reduces the chances of microbial growth in these passages that can contaminate a next dispensed dose of fluid.

For this purpose, the additional plug of the cap 102 can include an elongated body shaped and sized to substantially occupy, or fill, the space in a channel of the dispensing plug 104 when the cap 102 secures the dispensing plug 104. In some embodiments, it can be beneficial to have the tip 116 of the dispensing plug 104 secured/closed by the additional plug, even when the pressure in the flexible container 106 increases to a point that would normally cause the fluid to be dispensed.

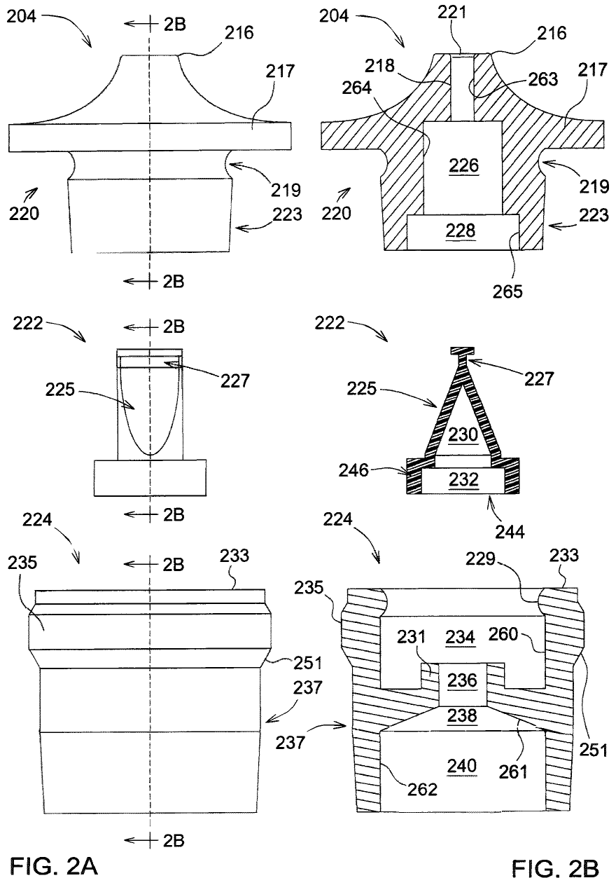

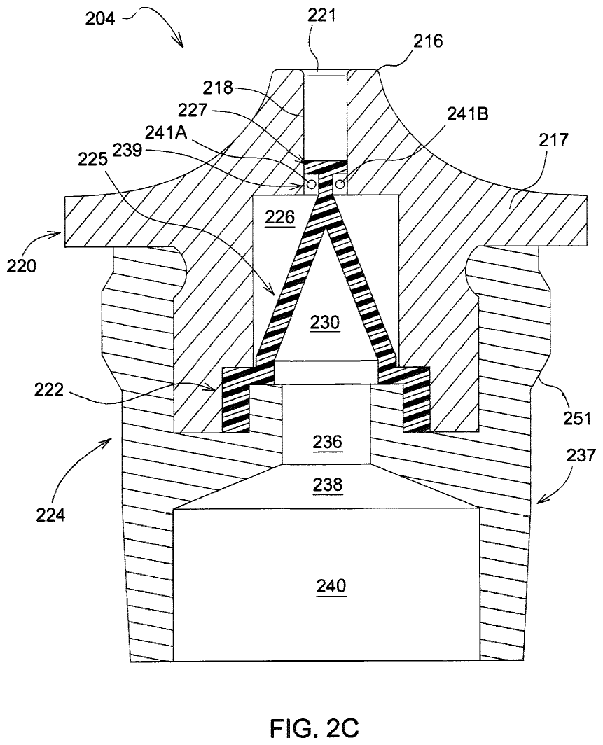

FIG. 2A is an exploded view of a dispensing plug 204 that can be utilized with the flexible container 106. FIG. 2B is an exploded, cross-sectional view of the dispensing plug 204 at cross-section 2-2. FIG. 2C is a cross-sectional view of the dispensing plug 204. FIGS. 2A-2C are described together herein for clarity.

The dispensing plug 204 can, in some embodiments, be representative of the plug 104. The dispensing plug 204 includes a dispensing plug distal portion 220, a dispensing plug valve 222, and a dispensing plug proximal portion 224. The dispensing plug 204 may be made wholly or partially of silicone or another polymer.

The dispensing plug proximal portion 224 includes an annular ridge 229 at a distal end of the dispensing plug proximal portion 224, retaining walls 231, distal annular surface 233, a retention volume 234, an outer ridge 235 at the distal end of the dispensing plug proximal portion 224, a flow channel 236, a sealing wall 237, a tapered channel 238, and an inlet channel 240. The sealing wall 237 and the outer ridge 235 form an airtight seal between the dispensing plug 104 and the opening 107 of the flexible container 106 when the dispensing plug 104 is attached to the flexible container 106. In some embodiments, the sealing wall 237 can be compression- or friction-fit inside the opening 107 of the flexible container 106, such that when the dispensing plug proximal portion 224 is pressed into the opening 107, the airtight seal is formed at a tapered interface 251 of the sealing wall 237 and the outer ridge 235.

The retention volume 234 is defined by a first inner surface 260 of the dispensing plug proximal portion 224. The first inner surface 260 is at the distal end of the dispensing plug proximal portion 224, opposite the outer ridge 235. The flow channel 236 is defined by the retaining walls 231, and the tapered channel 238 is defined by an inner tapered surface 261. The inlet channel 240 is defined by a second inner surface 262 at a proximal end of the dispensing plug proximal portion 224. The inner tapered surface 261 is formed between the second inner surface 262 and the retaining walls 231. The inlet channel 240, tapered channel 238, flow channel 236, and retention volume 234 are in sequential order when moving from the proximal end to the distal end of the dispensing plug proximal portion 224.

The dispensing plug valve 222 includes a tapered body 225 defining a tapered volume 230, a proximal retention cavity 232 defined by a valve annular base 246, and a valve tip 342. The proximal retention cavity 232 is configured to secure the dispensing plug valve 222 to the dispensing plug proximal portion 224. For example, in some embodiments, the valve annular base 246 of the dispensing plug valve 222 is compression- or friction-fit against the retaining walls 231 of the dispensing plug proximal portion 224.

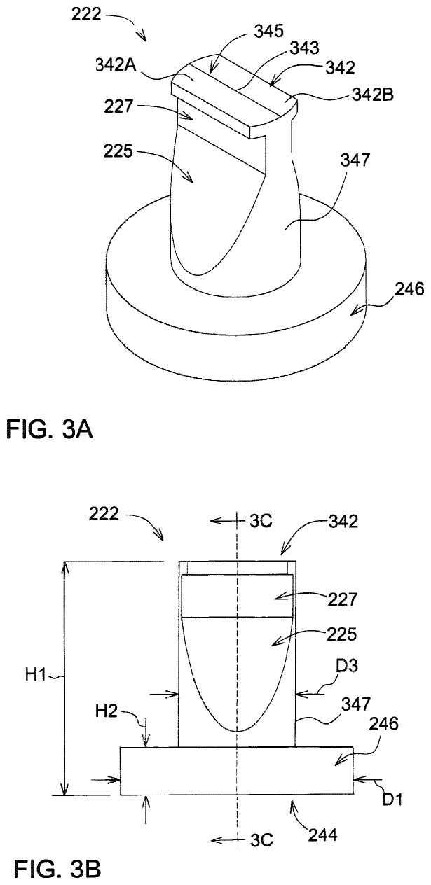

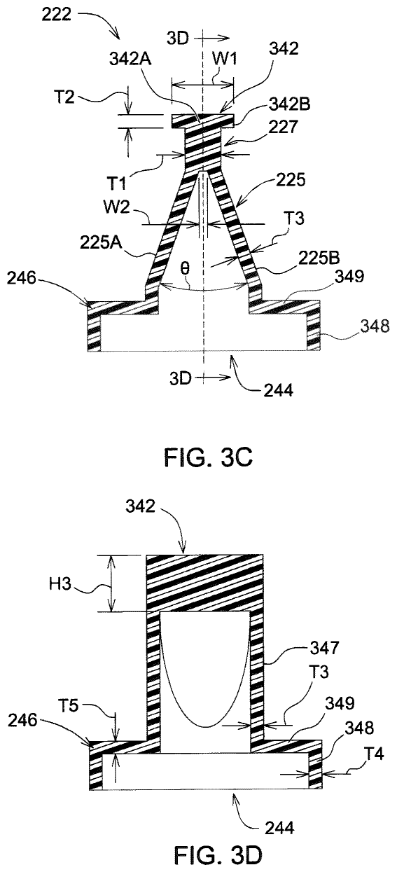

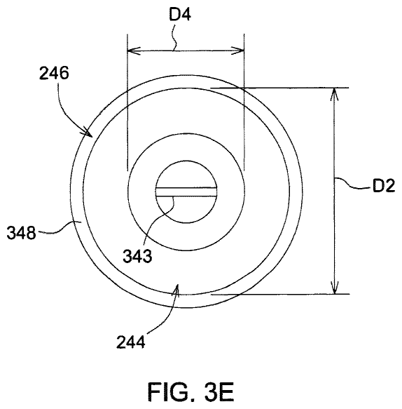

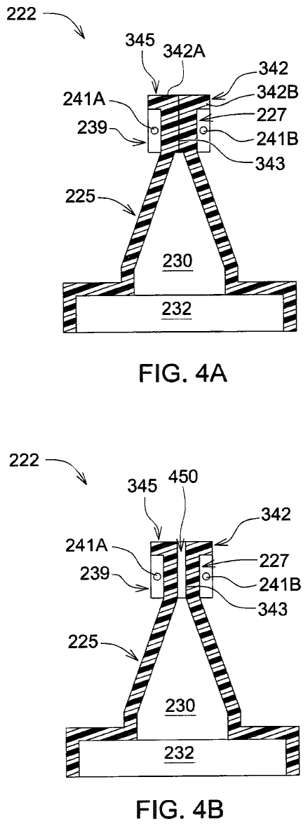

A magnet system 239, including two or more magnets (e.g., a first magnet 241A and a second magnet 241B), is disposed at a distal end of the dispensing plug valve 222. The two or more magnets are opposing magnets that are magnetically attracted to each other to create a magnetic biasing force. The magnetic biasing force biases a first lip 342A of the valve tip 342 and a second lip 342B of the valve tip 342 together (as shown in FIG. 3A, FIG. 3C, FIG. 4A, and FIG. 4B). In some embodiments, one of the first magnet 241A or the second magnet 241B can be replaced with a magnetic object. The magnetic object can include a metallic object, a ferromagnetic material, or other material that is not necessarily a magnet but is attracted to magnets, or can be magnetized.

The magnet system 239 is retained in position on the dispensing plug valve 222 in a retention region 227. The retention region 227 is disposed between the tapered body 225 and the valve tip 342. In some embodiments, the magnet system 239 is retained in the retention region 227 using an adhesive or bonding agent. In other embodiments, the valve tip 342, or another structure adjacent the retention region 227, retains the magnet system 239 in the retention region 227 via friction or interference fit. In yet other embodiments, the one or more of magnets of the magnet system 239 can, at least in part, facilitate retention of themselves in the retention region 227 via the magnetic biasing force formed between the magnets, which can be bolstered by one or more structural features of the retention region 227 for bracing the magnets.

The dispensing plug valve 222 is a one-way valve for dispensing fluids. Generally, the one-way valve can include any type of a one-way valve suitable to allow egress of the fluid from an inlet 244 through a valve outlet 343 (as shown in FIG. 3A) and the valve tip 342, and to further prevent ingress of gases, liquids, and/or solids through the valve tip 342, into the valve outlet 343, and to the inlet 244. For example, the dispensing plug valve 222 as shown in FIGS. 2A-3E includes a Duckbill valve; however, in other embodiments, the dispensing plug valve 222 can include a flapper valve, an umbrella valve, or any other suitable type of check valve.

The dispensing plug distal portion 220 includes a tip 216 at a distal end of the dispensing plug distal portion 220, a sealing ledge 217, a flow path 218 defined by flow path wall 263, an annular retention groove 219, an outlet 221 at the distal end of the dispensing plug distal portion 220, a proximal wall 223 at a proximal end of the dispensing plug distal portion 220, a valve cavity 226 defined by valve cavity walls 264, and a valve retention cavity 228. The sealing ledge 217 is disposed between the tip 216 and the proximal wall 223. The annular retention groove 219 is disposed between the sealing ledge 217 and the proximal wall 223.

The tip 216 of the dispensing plug distal portion 220 is similar to the tip 116 of FIG. 1. The flow path 218 is formed between the valve cavity 226 and the outlet 221. The valve retention cavity 228 is defined by valve retention cavity wall 265 at a proximal end of the dispensing plug distal portion 220. The valve retention cavity wall 265 is configured to secure the dispensing plug valve 222 between the dispensing plug distal portion 220 and the dispensing plug proximal portion 224. For example, in some embodiments, the valve retention cavity wall 265 is compression- or friction-fit within the retention volume 234 and against the valve annular base 246 of the dispensing plug valve 222. The annular retention groove 219 is configured to engage the annular ridge 229 to secure the dispensing plug distal portion 220 within the dispensing plug proximal portion 224. In some embodiments, the annular retention groove 219 is disposed within the annular ridge 229 to secure the dispensing plug distal portion 220 within the dispensing plug proximal portion 224. An airtight seal is formed between the sealing ledge 217 and the distal annular surface 233 to prevent microbial ingress into the flexible container 106 and to further prevent fluid egress from the dispensing plug 204 when the dispensing plug valve 222 is closed.

During use, fluid from the flexible container 106 can be transmitted from the opening 107 at the dispensing end 108 into the inlet channel 240. The fluid flows through the inlet channel 240, the tapered channel 238, the flow channel 236, and the tapered volume 230 as driven by gravity or by application of a compression force(s) against the outer surface of the body 110 of the flexible container 106. Fluid from the dispensing plug valve 222 can be transmitted from the tapered volume 230 into the flow path 218 by applying compression force(s) against the outer surface of the body 110 of the flexible container 106, which increased the fluid pressure within the tapered volume 230 and forces the fluid out of the tapered volume 230 and into the flow path 218.

FIG. 3A is a perspective view of the dispensing plug valve 222. FIG. 3B is a side view of the dispensing plug valve 222. FIG. 3C is a cross-sectional view of the dispensing plug valve 222 at a cut line 3C-3C. FIG. 3D is a cross-sectional view of the dispensing plug valve 222 at a cut line 3D-3D. FIG. 3E is a bottom view of the dispensing plug valve 222. FIGS. 3A-3E are described together herein for clarity.

In some embodiments, the dispensing plug valve 222 is wholly or partially formed of an elastic and hydrophobic material, while the remaining portions of the dispensing plug 204 (e.g., the dispensing plug distal portion 220 and dispensing plug proximal portion 224) are formed of a rigid and hydrophobic material. Examples of suitable rigid materials include polyethylene such as a low-density polyethylene (LDPE), a high-density polyethylene (HDPE), a cyclic olefin copolymer (COC), a polyetherimide (PEI), a polytetrafluoroethylene (PTFE), a polyoxymethylene (POM), and combinations thereof. Examples of suitable elastic materials include silicone, other elastomeric polymers, or thermoplastic elastomers. In further embodiments, the dispensing plug valve 222 is wholly or partially formed of a rigid hydrophobic material, while the remaining portions of the dispensing plug 204 are formed of an elastic and hydrophobic material. In still further embodiments, both of the dispensing plug valve 222 and the remaining portions of the dispensing plug 204 are formed of a rigid material or an elastic material. Generally, the material of the dispensing plug valve 222 can be selected to promote the sealing characteristics of the dispensing plug valve 222.

The dispensing plug valve 222 includes the valve tip 342 at a distal end thereof that further includes the valve outlet 343, and the inlet 244 at an opposing proximal end of the dispensing plug valve 222 that is configured to be in fluid communication with the flow channel 236 of the dispensing plug proximal portion 224 when assembled. The inlet 244 corresponds to an ingress point of fluids into the dispensing plug valve 222. The valve outlet 343 corresponds to an egress point of fluids out the valve tip 342. As previously described, the retention region 227 is disposed between the tapered body 225 and the valve tip 342. The retention region 227 has a first thickness T1 that is about 0.5 mm to about 1.5 mm. The valve tip 342 has a first width W1 and a second thickness T2. The first width W1 is about 1 mm to about 2.5 mm, such as about 1.5 mm to about 2 mm. The second thickness T2 that is about 0.2 mm to about 0.8 mm, such as about 0.4 mm to about 0.6 mm.

The dispensing plug valve 222 includes the valve annular base 246. The tapered body 225 is coupled to the valve annular base 246. As shown in FIG. 3B, the tapered body 225 has a first height H1. The first height H1 is about 6 mm to about 8 mm, such as about 6.5 mm to about 7.5 mm. The valve annular base 246 has a first diameter (e.g., an outer diameter) D1 and a second diameter (e.g., an inner diameter) D2 (shown in FIG. 3E). The first diameter D1 is about 6 mm to about 8 mm, such as about 6.5 mm to about 7.5 mm. The second diameter D2 is about 5 mm to about 7 mm, such as about 5.5 mm to about 6.5 mm. The valve annular base 246 has a second height H2. The second height H2 is about 1 mm to about 2 mm, such as about 1.2 mm to about 1.8 mm.

The tapered body 225 includes a first tapered wall 225A and a second tapered wall 225B. A taper angle θ between the first tapered wall 225A and the second tapered wall 225B is about 30° to about 50°, such as about 35° to about 45°. In some embodiments, a second width W2 between an upper end of the first tapered wall 225A and upper end of the second tapered wall 225B is about 0.1 mm to about 0.4 mm, such as about 0.2 mm to about 0.3 mm. The dispensing plug valve 222 has a third height H3 from the upper end of the first tapered wall 225A and the upper end of the second tapered wall 225B to a distal surface of the valve tip 342. The third height H3 is about 0.5 mm to about 2.5 mm, such as about 1 mm to about 2 mm.

The tapered body 225 includes a curved wall 347 extending between the first tapered wall 225A and the second tapered wall 225B. The curved wall 347 is semi-annular between the first tapered wall 225A and the second tapered wall 225B, and annular proximal to both of the first and second tapered walls 225A and 225B such that the curved wall 347 defines a circumference adjacent a proximal end of the tapered body 225 (e.g., near the valve annular base 246). As shown in FIGS. 3C and 3D, the annular wall 347 has a third thickness T3. The third thickness T3 is about 0.1 mm to 0.7 mm, such as about 0.3 mm to about 0.5 mm. The tapered body has a third diameter (e.g., an outer diameter) D3 (FIG. 3B) and a fourth diameter (e.g., an inner diameter) D4 (FIG. 3E). The third diameter D3 is about 2 mm to about 5 mm, such as about 3 mm to about 4 mm. The fourth diameter D4 is about 1 mm to about 4 mm, such as about 2 mm to about 3 mm.

As shown in FIG. 3D, the valve annular base 246 includes a sidewall 348 and an upper surface 349. The sidewall 348 has a fourth thickness T4 of about 0.1 mm to 0.7 mm, such as about 0.3 mm to about 0.5 mm. The upper surface 349 has a fifth thickness T5 of about 0.1 mm to 0.7 mm, such as about 0.3 mm to about 0.5 mm.

FIG. 4A is a schematic, cross-sectional view of an example dispensing plug valve 222 with a magnet system 239 in a closed state. FIG. 4B is a schematic, cross-sectional side view of the example dispensing plug valve 222 with a magnet system 239 of FIG. 4A in an open state.

In some embodiments, the valve tip 342 and the retention region 227 of the dispensing plug valve 222 exert force(s) that cause the dispensing plug valve 222 to be in a closed state as shown in FIG. 4A. For descriptive purposes, these force(s) are referred to herein as biasing force(s). The biasing force(s), in some embodiments, is at least partially created by the materials and structure of the dispensing plug valve 222, which is inherently present when no opposing force(s) is being applied to the valve tip 342. The biasing force(s) facilitate sealing of the dispensing plug valve 222 unless, or until, the biasing force(s) are overcome by opposing force(s) such as, for example, fluid pressure on the valve outlet 343. For descriptive purposes, the term “sealing” means that a fluid cannot ingress or egress through the valve tip 342. The fluid pressure can be caused by compression force(s) against the squeezable wall of a flexible container, such as the body 110 of the flexible container 106 of FIG. 1.

The magnet system 239, including the two or more magnets (e.g., the first magnet 241A or the second magnet 241B), is disposed at a distal end of the dispensing plug valve 222, proximate to the valve tip 342. The magnets are placed on opposite sides of the retention region 227 of the tapered body 225 to create the magnetic biasing force between the valve tip lips 342a and 342b, which causes the valve tip lips 342a and 342b to press against each other and prevent ingress and/or egress into the flexible container 106. Thus, the magnet system 239 can prevent microbial ingress from the system 100 exterior by creating a one-way fluid flow that prevents backflow into the flexible container 106. Independently, taper angle θ between the first tapered wall 225A and the second tapered wall 225B can also be adjusted to promote or reduce biasing force between the valve tip lips 342a and 342b, with a larger taper angle θ promoting an increased biasing force and a smaller taper angle θ promoting a lower biasing force.

An adjustable sealing region 345 converts the system 100 into a multi-dose, preservative free medical device. The adjustable sealing region 345 of the magnetically controlled dispensing plug valve 222 can be altered in size so the system 100 can be utilized with a variety of product viscosities while the strength of the magnets can be varied to impact actuation force. Thus, the dispensing plug valve 222 can be utilized with a variety of ophthalmic formulations, while being adjustable to meet target product profiles for dosing volume and actuation force.

As shown in FIG. 4B, when opposing force(s) overcome the biasing force(s), the dispensing plug valve 222 at least partially opens to form a fluid path 450 for the fluid to flow from the inlet 244 to the valve outlet 343, thereby allowing the fluid to be dispensed out of the valve tip 342 in proportion to an amount by which the opposing force(s) exceed the biasing force(s). The fluid path 450 is defined between the tapered volume 230 and the valve tip 342 within the retention region 227.

When the opposing force(s) no longer overcome the biasing force(s) (e.g., as a result of a decrease in, or cessation of, the compression force), the biasing force(s), by virtue of their continuous or constant nature, immediately cause the dispensing plug valve 222 to again seal the fluid path 450 between the inlet 244 and the valve outlet 343. In this way, the magnetic system 239 can seal the dispensing plug valve 222 whenever fluids are not being dispensed, thereby preventing microbial ingress. Accordingly, in various embodiments, microbial ingress, for example, to a container such as the flexible container 106 of system 100 of FIG. 1, can likewise be reduced or prevented.

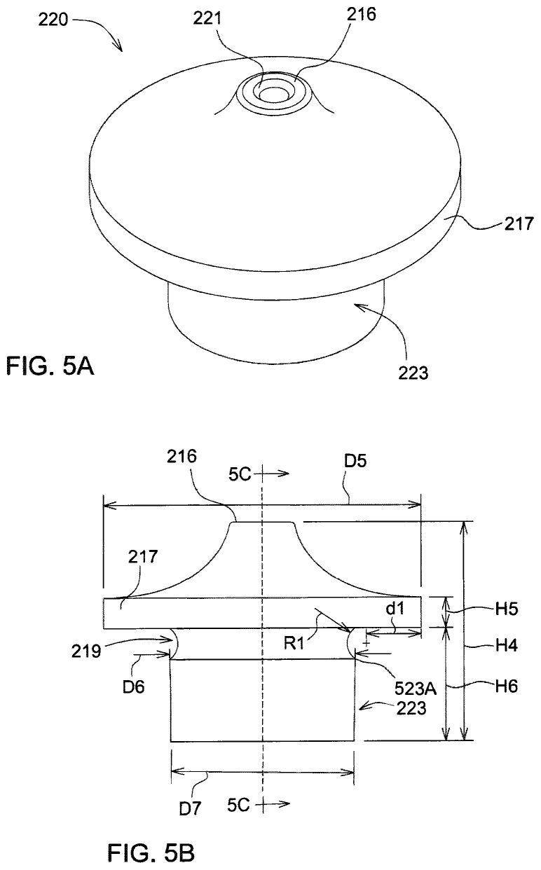

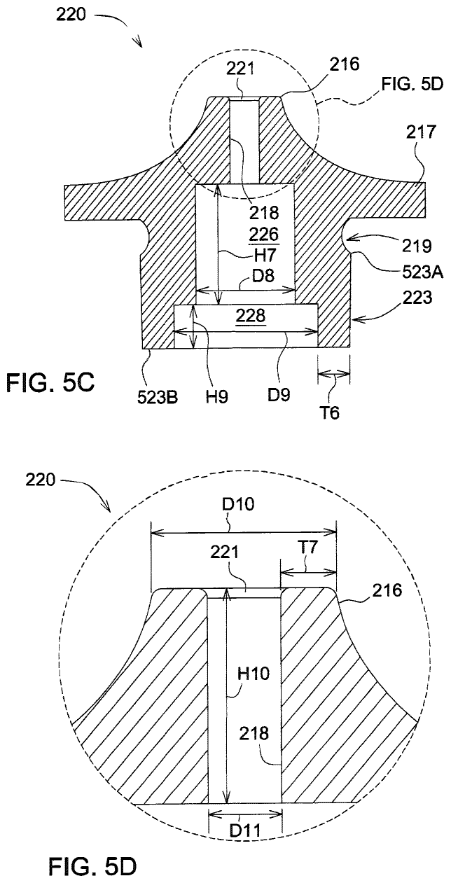

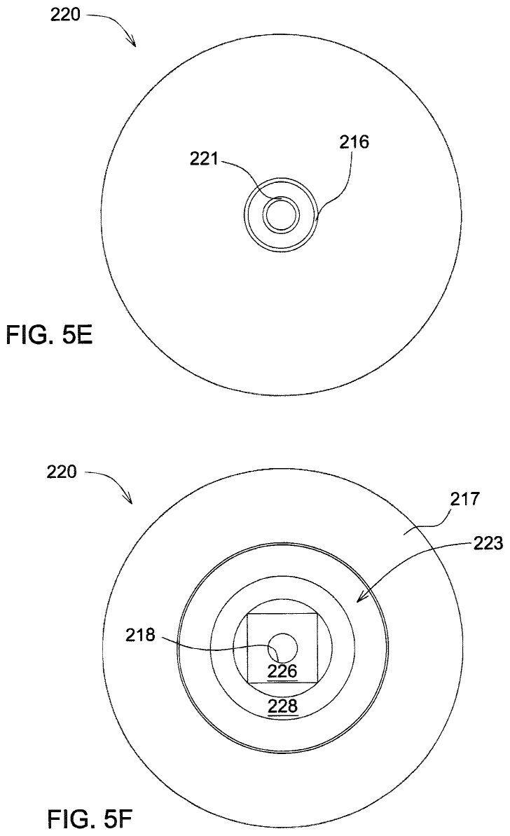

FIG. 5A is a perspective of the dispensing plug distal portion 220. FIG. 5B is a side view of the dispensing plug distal portion 220. FIG. 5C is a cross-sectional view of the dispensing plug distal portion 220. FIG. 5D is a cross-sectional view of the tip 216. FIG. 5E is a top view of the dispensing plug distal portion 220. FIG. 5F is a bottom view of the dispensing plug distal portion 220. FIGS. 5A-5F are described together herein for clarity. The dispensing plug distal portion 220 is disposed within the retention volume 234 of the dispensing plug proximal portion 224 and is configured to secure the dispensing plug valve 222 between the dispensing plug distal portion 220 and the dispensing plug proximal portion 224. For example, in some embodiments, the valve retention cavity wall 265 is compression- or friction-fit within the retention volume 234 and against the valve annular base 246 of the dispensing plug valve 222.

The dispensing plug distal portion 220 has a fourth height H4 from the proximal region 523B of the proximal wall 223 to the tip 216. The fourth height H4 is about 7 mm to about 10 mm, such as about 8 mm to about 9 mm. The sealing ledge 217 has a fifth height H5 of about 1.0 mm to about 1.5 mm, such as about 1.1 mm to about 1.4 mm. The dispensing plug distal portion 220 has a sixth height H6 from the proximal region 523B of the proximal wall 223 to the sealing ledge 217 of about 3 mm to about 6 mm, such as about 4 mm to about 5 mm. The sealing ledge 217 has fifth diameter D5 of about 10 mm to about 15 mm, such as about 11 mm to about 13 mm. A distal region 523A of the proximal wall 223 has a sixth diameter D6 of about 5 mm to about 9 mm, such as about 7 mm to 8 mm. The proximal region 523B of the proximal wall 223 has a seventh diameter D7 of about 5 mm to about 9 mm, such as about 7 mm to 8 mm. In some embodiments, the seventh diameter D7 is less than the sixth diameter D6.

The annular retention groove 219 has a semi-circular shape defined by a first circle having a first radius R1. The first radius R1 is about 0.25 mm to about 1.25 mm, such as about 0.5 mm to about 1.0 mm. A distance d1 from an edge of the sealing ledge 217 to the center of the first circle is about 1 mm to about 4 mm, such as about 2 mm to about 3 mm.

Turning to FIG. 5C, the valve cavity 226 has an eighth diameter D8 and the valve retention cavity 228 has a ninth cavity D9. The eighth diameter D8 is about 2 mm to about 5 mm such as about 3 mm to about 4 mm. The ninth diameter D9 is about 4 mm to about 6 mm, such as about 4.5 mm to about 5.5 mm. The valve retention cavity 228 has a ninth height of H 9 and a sixth thickness T6 at the proximal region 523B of the proximal wall 223. The ninth height is about 0.5 mm to about 2.5 mm, such as about 1 mm to about 2 mm and the sixth thickness T6 is about 0.5 mm to about 1.5 mm, such as about 0.75 mm to about 1.25 mm.

As shown in FIG. 5D, the tip 216 has a tenth diameter D10 of about 1.5 mm to about 3.5 mm, such as about 2 mm to about 3 mm. The flow path 218 has an eleventh diameter D11 and a tenth height H10. The eleventh diameter D11 has a diameter of 0.25 mm to about 1.75 mm, such as about 0.75 mm to about 1.25 mm. The tenth height H10 is about 1 mm to about 5 mm, such as about 2 mm to about 4 mm. The outlet 221 has a seventh thickness T7 of about 0.25 mm to about 1.25 mm, such as about 0.5 mm to about 1.0 mm.

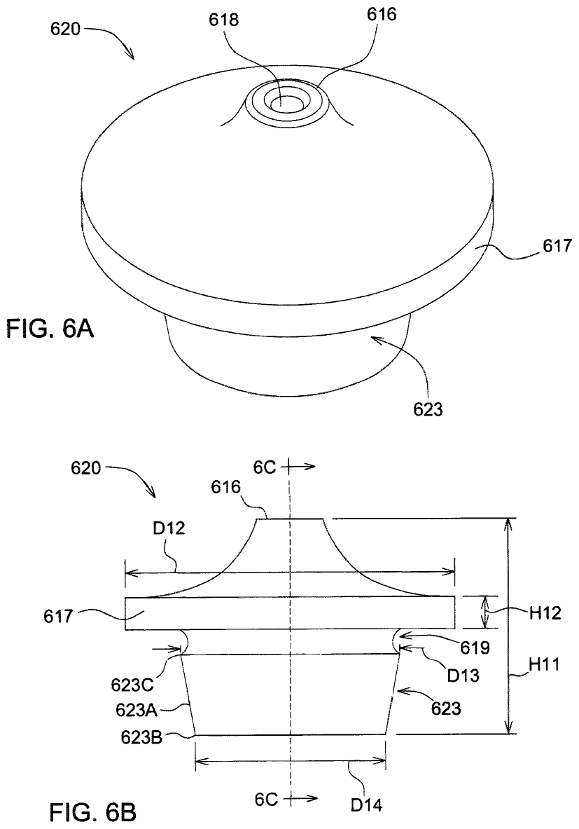

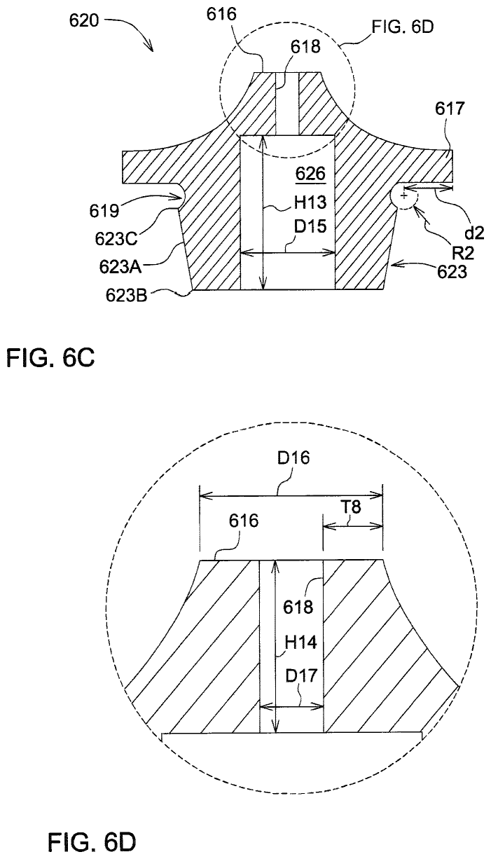

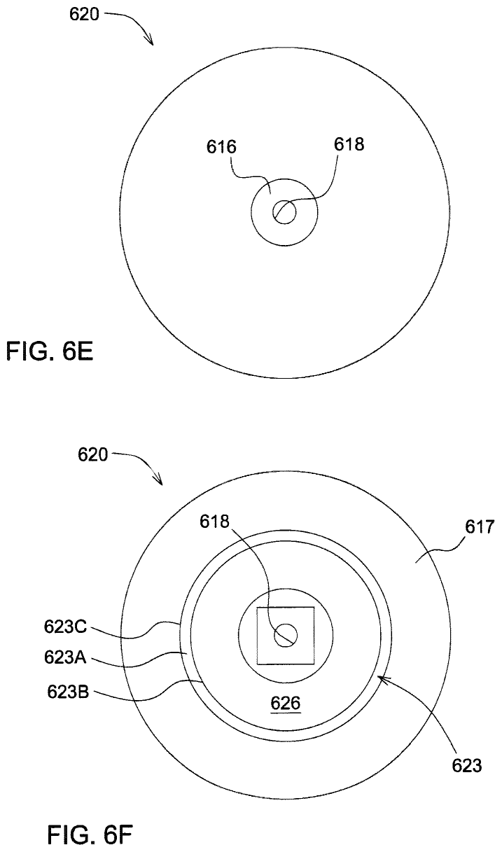

FIG. 6A is a perspective of a second dispensing plug distal portion 620. FIG. 6B is a side view of the second dispensing plug distal portion 620. FIG. 6C is a cross-sectional view of the second dispensing plug distal portion 620. FIG. 6D is a cross-sectional view of a tip 616. FIG. 6E is a distal portion view of the second dispensing plug distal portion 620. FIG. 6F is a bottom view of the second dispensing plug distal portion 620. FIGS. 6A-6F are described together herein for clarity. The second dispensing plug distal portion 620 includes the tip 616, a sealing ledge 617, a flow path 618, an annular retention groove 619, a proximal wall 623, and a valve cavity 626.

The second dispensing plug distal portion 620 is substantially similar to the dispensing plug distal portion 220, and can be utilized as an alternative to the dispensing plug distal portion 220. However, the second dispensing plug 620 has a single cavity (e.g., the valve cavity 626) instead of the valve cavity 226 and a valve retention cavity 228, and includes a tapered wall 623A. The tapered wall 623A enables the second dispensing plug distal portion 620 to be more easily inserted into the retention volume 234 of the dispensing plug proximal portion 224. Similar features to the dispensing plug distal portion 220 provide similar functionality as described above.

The second dispensing plug distal portion 620 has an eleventh height H11 from a proximal region 623B of the proximal wall 623 to the tip 616. The proximal region 623B is at a proximal end of the proximal wall 623. The eleventh height H11 is about 7 mm to about 10 mm, such as about 8 mm to about 9 mm. The sealing ledge 617 has a twelfth height H12 of about 1.0 mm to about 1.5 mm, such as about 1.1 mm to about 1.4 mm. The sealing ledge 617 has a twelfth diameter D12 of about 10 mm to about 15 mm, such as about 11 mm to about 13 mm. A distal region 623C of the proximal wall 623 is disposed between the annular retention groove 619 and the proximal region 623B of the proximal wall 223. The distal region 623C has a thirteenth diameter D13 of about 5 mm to about 10 mm, such as about 8 mm to 9 mm. The proximal region 623B of the proximal wall 623 has a fourteenth diameter D14 of about 5 mm to about 9 mm, such as about 7 mm to 8 mm. In some embodiments, the fourteenth diameter D14 is less than the thirteenth diameter D13. The tapered wall 623A of the proximal wall 623 spans between the distal region 623C and the proximal region 623B of the proximal wall 623.

The annular retention groove 619 has a semi-circular shape defined by a second circle having a second radius R2. The annular retention groove 619 is disposed between the sealing ledge 617 and the distal region 623C of the proximal wall 623. The second radius R2 is about 0.25 mm to about 1.25 mm, such as about 0.5 mm to about 0.75 mm. A distance d2 from an edge of the sealing ledge 617 to the center of the second circle is about 0.5 mm to about 3.5 mm, such as about 1.5 mm to about 2.5 mm.

The valve cavity 626 has a fifteenth diameter D15. The valve cavity is formed between the proximal region 623B of the proximal wall 623 and the flow path 618. The fifteenth diameter D15 is about 2 mm to about 5 mm such as about 3 mm to about 4 mm. The valve cavity 626 has a thirteenth height of H13 that is about 4.0 mm to about 7.0 mm, such as about 5.0 mm to about 6.0 mm.

The tip 616 has a sixteenth diameter D16 of about 1.5 mm to about 3.5 mm, such as about 2 mm to about 3 mm. The flow path 618 has a seventeenth diameter D17 and a fourteenth height H14. The seventeenth diameter D17 has a diameter of 0.25 mm to about 1.75 mm, such as about 0.75 mm to about 1.25 mm. The fourteenth height H14 is about 1 mm to about 5 mm, such as about 2 mm to about 3 mm. The tip 616 has an eighth thickness T8 of about 0.25 mm to about 1.25 mm, such as about 0.5 mm to about 1.0 mm.

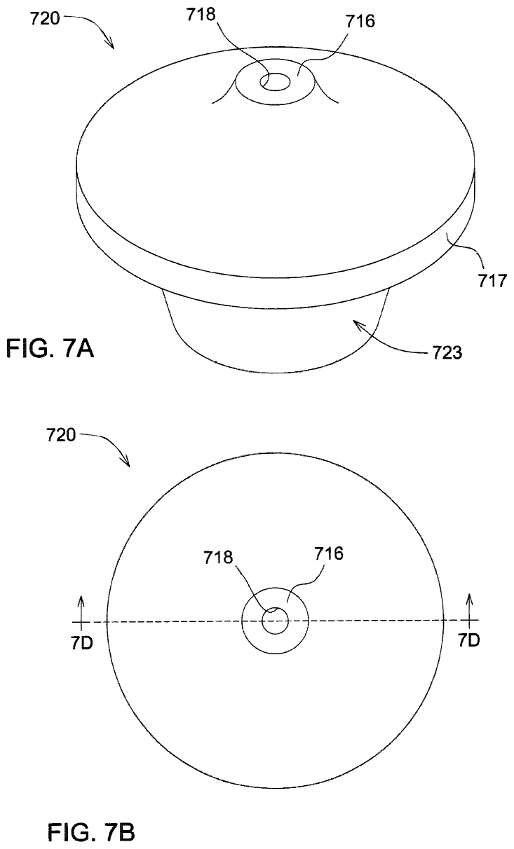

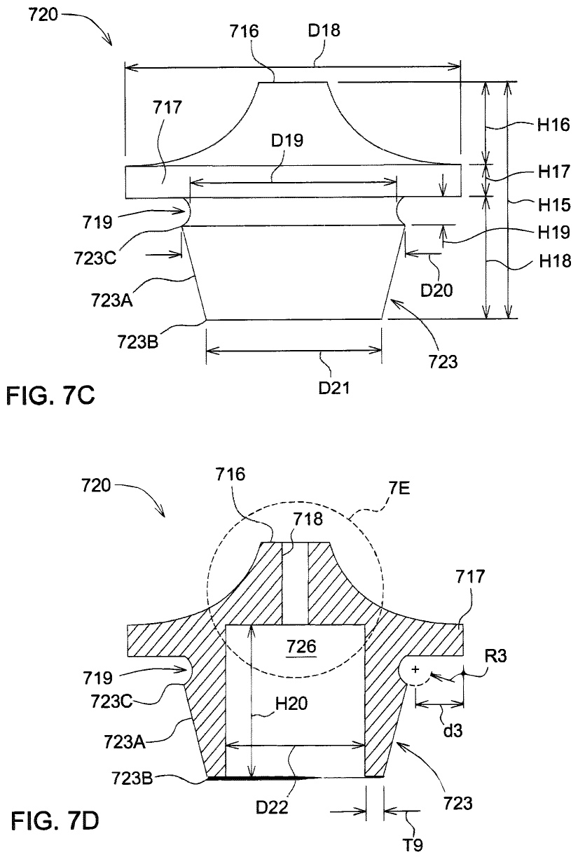

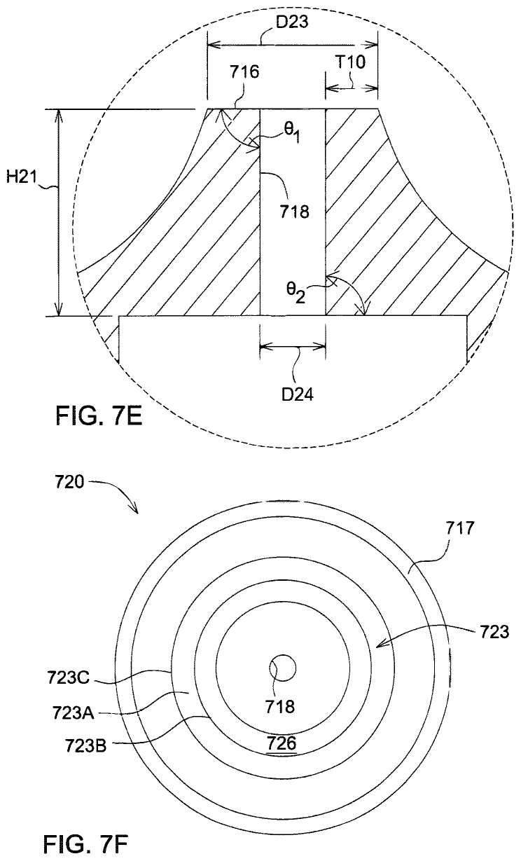

FIG. 7A is a perspective of a third dispensing plug distal portion 720. FIG. 7B is a top view of the third dispensing plug distal portion 720. FIG. 7C is a side view of the third dispensing plug distal portion 720. FIG. 7D is a cross-sectional view of the third dispensing plug distal portion 720. FIG. 7E is a cross-sectional view of a tip 716. FIG. 7F is a bottom view of the third dispensing plug distal portion 720. The third dispensing plug distal portion 720 includes the tip 716, a sealing ledge 717, a flow path 718, an annular retention groove 719, a proximal wall 723, and a valve cavity 726.

The third dispensing plug distal portion 720 is substantially similar to the dispensing plug distal portion 220, and can be utilized as an alternative to the dispensing plug distal portion 220. However, the third dispensing plug distal portion 720 has a single cavity (e.g., the valve cavity 726) instead of the valve cavity 226 and a valve retention cavity 228, and includes a tapered wall 723A. The third dispensing plug distal portion 720 has a larger annular retention groove 719 than the second dispensing plug distal portion 620. The tapered wall 723A enables the third dispensing plug distal portion 720 to be more easily inserted into the retention volume 234 of the dispensing plug proximal portion 224. Similar features to the dispensing plug distal portion 220 provide similar functionality as described above.

The third dispensing plug distal portion 720 has a fifteenth height H15 from a proximal region 723B of the proximal wall 723 to the tip 716. The proximal region 723B is at a proximal end of the proximal wall 723. The fifteenth height H15 is about 7 mm to about 10 mm, such as about 8 mm to about 9 mm. A sixteenth height H16 from the tip 716 to the sealing ledge 717 is about 2 mm to about 5 mm, such as about 3 mm to about 4 mm. The third dispensing plug distal portion 720 has a eighteenth height H18 from the proximal region 723B of the proximal wall 723 to the sealing ledge 717 of about 3 mm to about 6 mm, such as about 4 mm to about 5 mm. The sealing ledge 717 has a seventeenth height H17 of about 1.0 mm to about 1.5 mm, such as about 1.1 mm to about 1.4 mm. The sealing ledge 717 has an eighteenth diameter D18 of about 10 mm to about 15 mm, such as about 11 mm to about 13 mm. A distal region 723C of the proximal wall 723 is disposed between the annular retention groove 719 and the proximal region 723B of the proximal wall 723. The distal region 723C has a twentieth diameter D20 of about 5 mm to about 10 mm, such as about 8 mm to 9 mm. The proximal region 723B of the proximal wall 223 has a twenty-first diameter D21 of about 5 mm to about 9 mm, such as about 6 mm to 7 mm. In some embodiments, the twenty-first diameter D21 is less than the twentieth diameter D20. A tapered wall 723A of the proximal wall 723 spans between the distal region 723C and the proximal region 723B of the proximal wall 723.

The annular retention groove 719 has a semi-circular shape defined by a third circle having a third radius R3. The annular retention groove 619 is disposed between the sealing ledge 617 and the distal region 623C of the proximal wall 623. The third radius R3 is about 0.25 mm to about 1.25 mm, such as about 0.5 mm to about 1.0 mm. A distance d3 from an edge of the sealing ledge 717 to the center of the third circle is about 1 mm to about 4 mm, such as about 2 mm to about 3 mm. The annular retention groove 719 has a nineteenth diameter D19 of about 6 mm to about 10 mm, such as about 7 mm to 9 mm. The annular retention groove 719 has a nineteenth height H19 of about 0.8 mm to about 1.5 mm, such as about 1.0 mm to about 1.2 mm

The valve cavity 726 has a twenty-second diameter D22. The valve cavity is formed between the proximal region 623B of the proximal wall 623 and the flow path 618. The twenty-second diameter D22 is about 2 mm to about 6 mm, such as about 4.5 mm to about 5.5 mm. The valve cavity 726 has a twentieth height of H 20 that is about 4.0 mm to about 7.0 mm, such as about 5.0 mm to about 6.0 mm. The third dispensing plug distal portion 720 has a ninth thickness T9 at a proximal region 723B of the proximal wall 723 which is about 0.25 mm to about 1.5 mm, such as about 0.5 mm to about 1.0 mm

The tip 716 has a twenty-third diameter D23 of about 1.5 mm to about 3.5 mm, such as about 2 mm to about 3 mm. The flow path 718 has a twenty-fourth diameter D24 and a twenty-first height H21. The twenty-fourth diameter D24 has a diameter of 0.25 mm to about 1.75 mm, such as about 0.75 mm to about 1.25 mm. The twenty-first height H21 is about 1 mm to about 5 mm, such as about 2.5 mm to about 3.5 mm. The tip 716 has a tenth thickness T10 of about 0.25 mm to about 1.25 mm, such as about 0.5 mm to about 1.0 mm.

The third dispensing plug distal portion 720 includes a first angle Φ1 and a second angle Φ2. The first angle Φ1 is defined between the tip 716 and the flow path 718. The distal end of the tip 716 may include a surface that is tapered downward as the tip 716 extends away from the center of the third dispensing plug distal portion 720. The taper is defined by the first angle Φ1. The second angle Φ2 is defined between the valve cavity 726 and the flow path 718. In some embodiments, the second angle Φ2 enables a slight expansion of the flow path 718 from the valve cavity 726 to the tip 716. The first angle Φ1 and the second angle Φ2 are less than 90°, such as about 89.0° to about 89.9°, such as about 89.4° to about 89.7°.

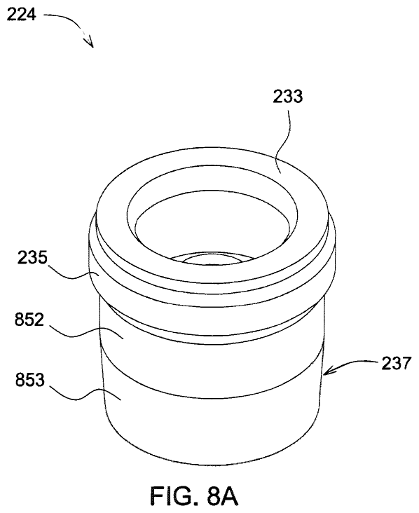

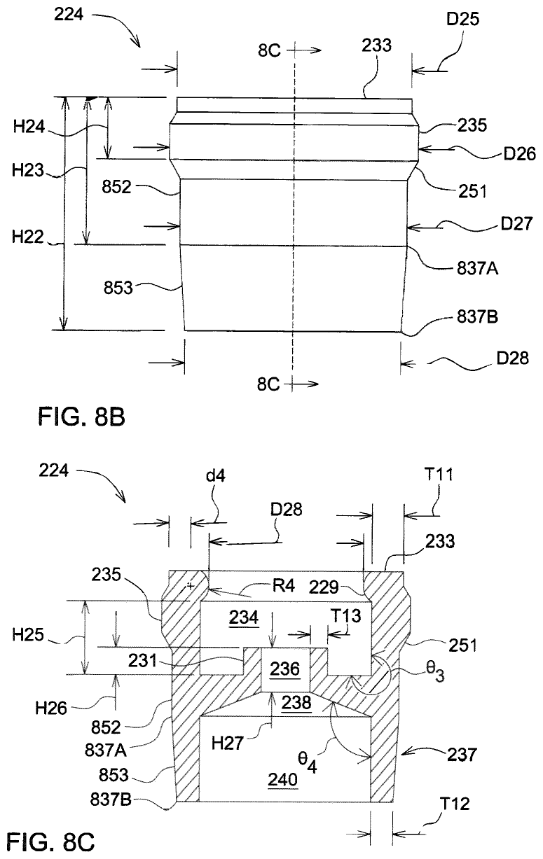

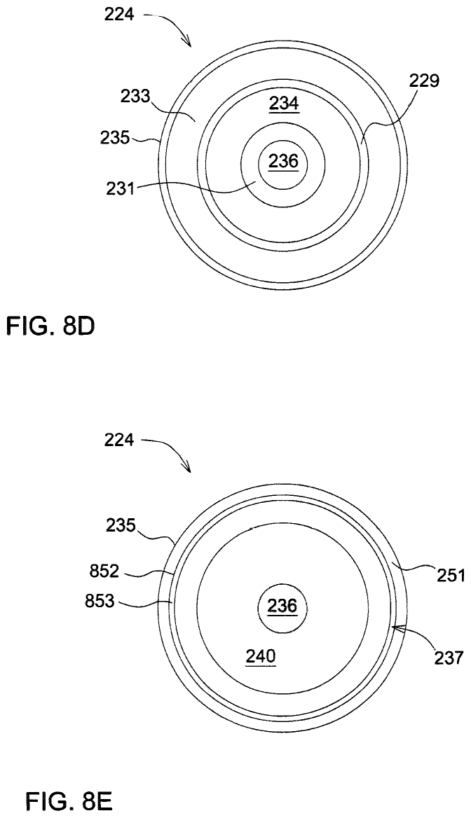

FIG. 8A is a perspective of the dispensing plug proximal portion 224. FIG. 8B is a side view of the dispensing plug proximal portion 224. FIG. 8C is a cross-sectional view of the dispensing plug proximal portion 224. FIG. 8D is a top view of the dispensing plug proximal portion 224. FIG. 8E is a bottom view of the dispensing plug proximal portion 224. FIGS. 8A-8E are described together herein for clarity. The dispensing plug proximal portion 224 is configured to receive the dispensing plug distal portion 220 within the retention volume 234 of the dispensing plug proximal portion 224 and to secure the dispensing plug valve 222 between the dispensing plug distal portion 220 and the dispensing plug proximal portion 224. For example, in some embodiments, the valve retention cavity wall 265 is compression- or friction-fit within the retention volume 234 and against the valve annular base 246 of the dispensing plug valve 222.

The distal annular surface 233 at a distal end of the dispensing plug proximal portion 224 has a twenty-fifth diameter D25 of about 8 mm to about 12 mm, such as about 9 mm to about 11 mm. The outer ridge 235 is disposed adjacent to the distal annular surface 233, and more proximal to the proximal end of the dispensing plug proximal portion 224 than the distal annular surface 233. The outer ridge 235 has a twenty-sixth diameter D26 of about 8 mm to about 12 mm, such as about 9 mm to about 11 mm. In some embodiments, the twenty-sixth diameter D26 of the outer ridge 235 is greater than the twenty-fifth diameter D25 of the distal annular surface 233. The sealing wall 237 includes a first portion 852 and a second portion 853. The second portion 853 is at a proximal end of the dispensing plug proximal portion 224, and the first portion 852 is disposed between the second portion 853 and the outer ridge 235. The sealing wall 237 has a twenty-seventh diameter D27 at an interface 837A of the first portion 852 and a second portion 853 and a twenty-eighth diameter D28 at a proximal region 837B of the sealing wall 237. The twenty-seventh diameter D27 is about 8 mm to about 12 mm, such as about 9 mm to about 11 mm, the twenty-eighth diameter D28 of about 8 mm to about 10 mm, such as about 8.5 mm to about 9.5 mm

The dispensing plug proximal portion 224 has a twenty-second height H22 from the distal annular surface 233 to the proximal region 837B of the sealing wall 237, a twenty-third height H23 from the distal annular surface 233 to the interface 837A of the first portion 852 and the second portion 853 of the sealing wall 237, and a twenty-fourth height H24 from the distal annular surface 233 to a proximal edge of the outer ridge 235. The twenty-second height H22 is about 8 mm to about 12 mm, such as about 9 mm to about 11 mm. The twenty-third height H23 is about 4 mm to about 8 mm, such as about 6 mm to about 7 mm. The twenty-fourth height H24 is about 1 mm to about 4 mm, such as about 2 mm to about 3 mm.

The distal annular surface 233 has an eleventh thickness T11 and the proximal region 837B of the sealing wall 237 has a twelfth thickness T12. The eleventh thickness T11 is about bout 0.5 mm to about 2 mm, such as about 1.25 mm to about 1.75 mm. The twelfth thickness T12 is about 0.5 mm to about 1.5 mm, such as about 0.75 mm to about 1.25 mm.

The annular ridge 229 is disposed at a distal end of the dispensing plug proximal portion 224 and has a semi-circular shape defined by a fourth circle having a fourth radius R4. The fourth radius R4 is about 0.25 mm to about 1.25 mm, such as about 0.5 mm to about 1.0 mm. A fourth distance d4 from an edge of the distal annular surface 233 to the center of the fourth circle is about 0.25 mm to about 1.5 mm, such as about 0.75 mm to about 1.25 mm.

From the proximal end to the distal end of the dispensing plug proximal portion 224, a fluid flows successively through the inlet channel 240, the tapered channel 238, the flow channel 236, and the retention volume 234. The retention volume 234 has a twenty-fifth height H25 of about 2 mm to about 5 mm, such as about 3 mm to about 4 mm. The retaining wall 231 has a twenty-sixth height H26 and a thirteenth thickness T13. The twenty-sixth height H26 is about 0.75 mm to about 1.75 mm, such as about 1.0 to about 1.5 mm. The thirteenth thickness is about 0.25 mm to about 1.25 mm, such as 0.5 mm to about 1.0 mm. In some embodiments, the retention volume 234 includes a third angle Φ3. The third angle Φ3 enables a slight expansion of the retention volume 234 from the proximal end of the retention volume 234 to the annular ridge 229. The third angle Φ3 is about 90° to about 93°, such as about 91° to about 92°. The expansion of the volume between the retaining wall 231 and the inner surface of the sealing wall 237 enables the dispensing plug valve 222 to be more easily compression- or friction-fit inside the retention volume 234.

The flow channel 236 has a twenty-seventh height H27 of about 1 mm to about 3 mm, such as about 1.5 mm to about 2.5 mm. The tapered channel 238 is defined by a fourth angle Φ4. The fourth angle Φ4 of the tapered channel 238 is about 108° to about 116°, such as about 110° to about 114°.

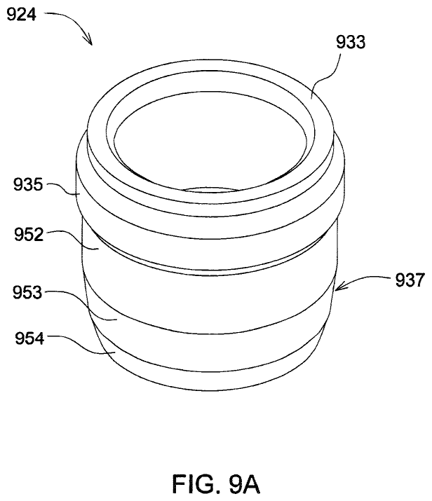

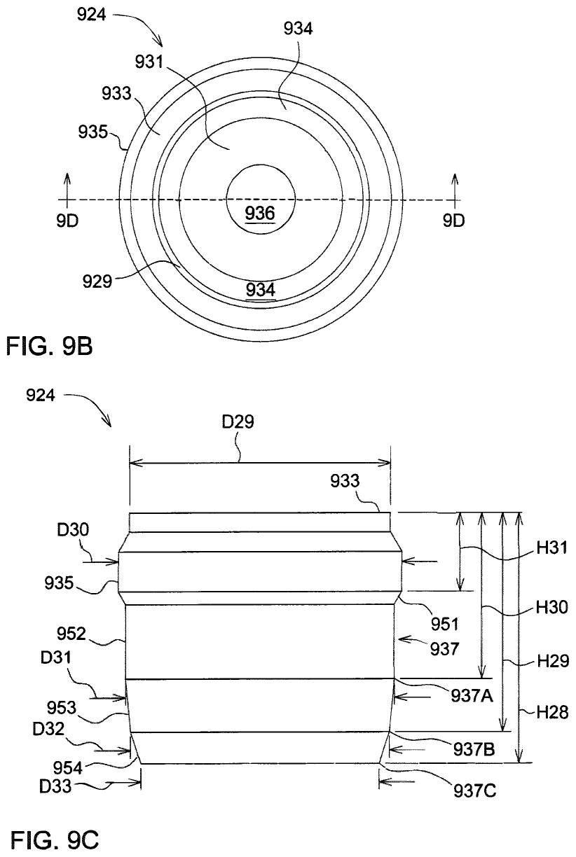

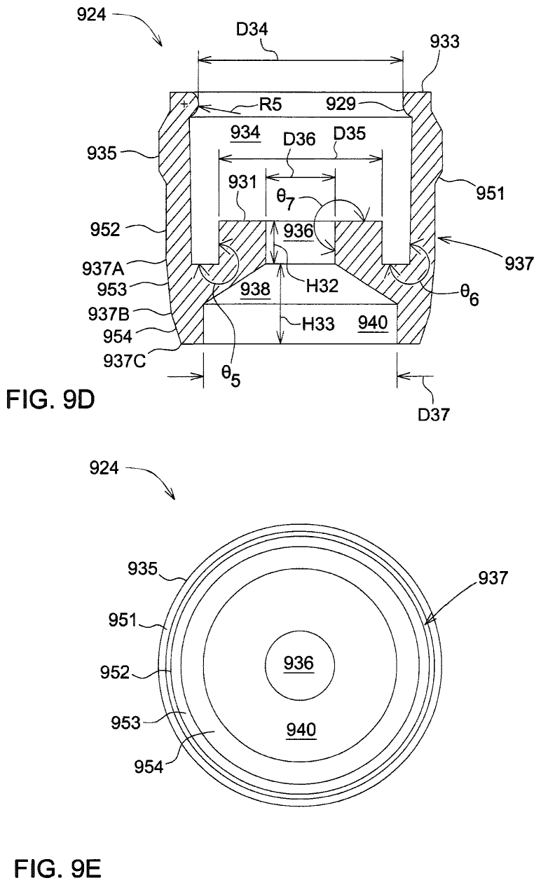

FIG. 9A is a perspective of a second dispensing plug proximal portion 924. FIG. 9B is a top view of the second dispensing plug proximal portion 924. FIG. 9C is a side of the second dispensing plug proximal portion 924. FIG. 9D is a cross-sectional view of the second dispensing plug proximal portion 924. FIG. 9E is a bottom view of the second dispensing plug proximal portion 924. FIGS. 9A-9E are described together herein for clarity. The second dispensing plug proximal portion 924 includes an annular ridge 929, retaining walls 931, distal annular surface 933, a retention volume 934, an outer ridge 935, a flow channel 936, a sealing wall 937, a tapered channel 938, and an inlet channel 940

The second dispensing plug proximal portion 924 is substantially similar to the dispensing plug proximal portion 224, and can be utilized as an alternative to the dispensing plug proximal portion 224. However, the second dispensing plug bottom 924 includes a third portion 954 of the sealing wall 937. The third portion 954 has a taper that enables the second dispensing plug proximal portion 924 to be more easily inserted into the opening 107 at the dispensing end 108 of the flexible container 106.

The distal annular surface 933 at a distal end of the second dispensing plug proximal portion 924 has a twenty-ninth diameter D29 of about 8 mm to about 12 mm, such as about 9 mm to about 11 mm. The outer ridge 935 is disposed adjacent to the distal annular surface 933, and more proximal to the proximal end of the second dispensing plug proximal portion 924 than the distal annular surface 933. The outer ridge 935 has a thirtieth diameter D30 of about 8 mm to about 12 mm, such as about 9 mm to about 11 mm. In some embodiments, the thirtieth diameter D30 of the outer ridge 935 is greater than the twenty-ninth diameter D29 of the distal annular surface 933. The sealing wall 937 includes a first portion 952, a second portion 953, and a third portion 954. The third portion 954 is at a proximal end of the second dispensing plug proximal portion 924, the second portion 953 is disposed between the first portion 952 and the third portion 954, and the first portion 952 is disposed between the second portion 953 and the outer ridge 935. The sealing wall 937 has a thirty-first diameter D31 at an interface 937A of the first portion 952 and a second portion 953, a thirty-second diameter D32 at an interface 937B of the second portion 953 and the third portion 954, and a thirty-third diameter D33 at a proximal region 937C of the sealing wall 937. The thirty-first diameter D31 is about 8 mm to about 12 mm, such as about 9 mm to about 11 mm, the thirty-second diameter D32 of about 7 mm to about 10 mm, such as about 9 mm to about 10 mm, and thirty-third diameter D33 of about 8 mm to about 10 mm, such as about 8.5 mm to about 9.5 mm. A tapered interface 951 is disposed between the first portion 952 and the outer ridge 935.

The second dispensing plug proximal portion 924 has a twenty-eighth height H28 from the distal annular surface 933 to the proximal region 937C of the sealing wall 937, a twenty-ninth height H29 from the distal annular surface 933 to the interface 937B of the second portion 953 and the third portion 954, and a thirtieth height H30 from the distal annular surface 933 to the interface 937A of the first portion 952 and the second portion 953 of the sealing wall 937, and a thirty-first height H31 from the distal annular surface 933 to proximal edge of the outer ridge 935. The twenty-eighth height H28 is about 8 mm to about 12 mm, such as about 9 mm to about 11 mm. The twenty-ninth height H29 is about 7 mm to about 10 mm, such as about 8 mm to about 9 mm. The thirtieth height H30 is about 4 mm to about 8 mm, such as about 6 mm to about 7 mm. The thirty-first height H31 is about 1 mm to about 4 mm, such as about 2.5 mm to about 3.5 mm.

The annular ridge 929 is disposed at a distal end of the dispensing plug proximal portion 224 and has a semi-circular shape defined by a fifth circle having a fifth radius R5. The fifth radius R5 is about 0.25 mm to about 1.25 mm, such as about 0.5 mm to about 1.0 mm. The retaining walls 931 have a thirty-second height H32. The thirty-second height H32 is about 0.75 mm to about 1.75 mm, such as about 1.25 to about 1.75 mm. In some embodiments, the retaining walls 931 include a fifth angle Φ5 and an inner surface of the sealing wall 937 has a sixth angle Φ6. The fifth angle Φ5 is about 90° to about 93°, such as about 90° to about 91°. The sixth angle Φ6 is about 90° to about 93°, such as about 91° to about 92°. The fifth angle Φ5 and the sixth angle Φ6 enables a slight expansion of the volume between the retaining wall 931 and the inner surface of the sealing wall 937. The expansion of the volume between the retaining wall 931 and the inner surface of the sealing wall 937 enables the dispensing plug valve 222 to be more easily compression- or friction-fit inside the retention volume 934.

From the proximal end to the distal end of the second dispensing plug proximal portion 924, a fluid flows successively through the inlet channel 940, the tapered channel 938, the flow channel 936, and the retention volume 934. The second dispensing plug proximal portion 924 has a thirty-third height H33 from the proximal region 937C of the sealing wall 937 to the flow channel 936. The thirty-third height H33 is about 1 mm to about 5 mm, such as about 2 mm to about 4 mm. The annular ridge 929 has a thirty-fourth diameter D34 of about 5 mm to about 9 mm, such as about 7 mm to about 8 mm. The retainer walls 931 have a thirty-fifth (e.g., outer) diameter D35 and a thirty-sixth (e.g., inner) diameter D36 defining the flow channel 936. The thirty-fifth diameter D35 is about 5 mm to about 9 mm, such as about 6 mm to about 7 mm. The thirty-sixth diameter D36 is about 1 mm to about 4 mm, such as about 2 mm to about 3 mm. The inlet channel 940 has a thirty-seventh diameter D37 of about 5 mm to about 9 mm, such as about 7 mm to about 8 mm. In some embodiments, the retaining walls 931 includes a seventh angle Φ7 defining the flow channel 936. The seventh angle Φ7 enables a slight expansion of the flow channel 936 from the proximal end of the flow channel 936 to the distal end of the flow channel 936. The seventh angle Φ7 is less than 90°, such as about 88.0° to about 89.9°, such as about 88.2° to about 88.8°.

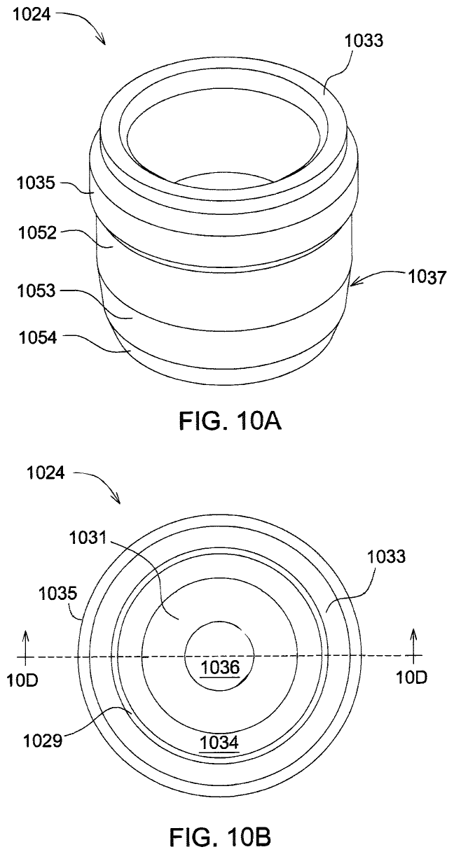

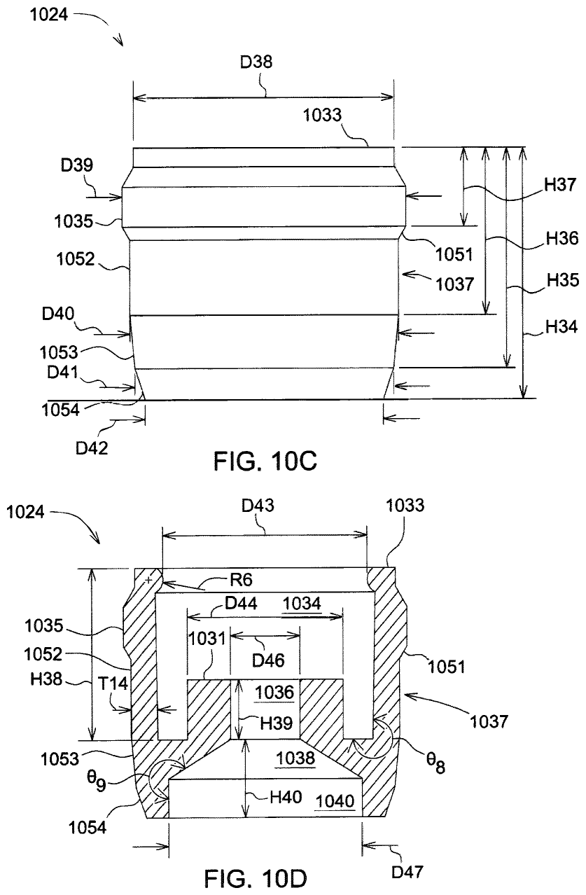

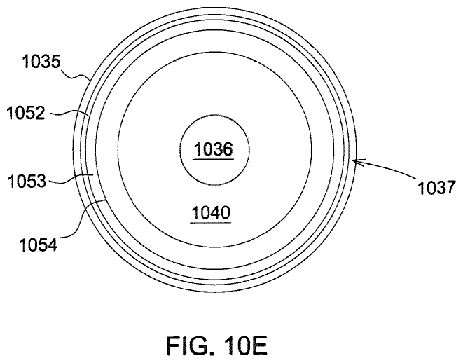

FIG. 10A is a perspective of a third dispensing plug proximal portion 1024. FIG. 10B is a top view of the third dispensing plug proximal portion 1024. FIG. 10C is a side view of the third dispensing plug proximal portion 1024. FIG. 10D is a cross-sectional view of the third dispensing plug proximal portion 1024. FIG. 10E is a bottom view of the third dispensing plug proximal portion 1024. The third dispensing plug proximal portion 1024 includes an annular ridge 1029, retaining walls 1031, distal annular surface 1033, a retention volume 1034, an outer ridge 1035, a flow channel 1036, a sealing wall 1037, a tapered channel 1038, and an inlet channel 1040.

The third dispensing plug proximal portion 1024 is substantially similar to the dispensing plug proximal portion 224, and can be utilized as an alternative to the dispensing plug proximal portion 224. However, the third dispensing plug proximal portion 1024 includes a third portion 1054 of the sealing wall 1037. The third portion 1054 has a taper that enables the third dispensing plug proximal portion 1024 to be more easily inserted into the opening 107 at the dispensing end 108 of the flexible container 106.

The distal annular surface 1033 is disposed at a distal end of the third dispensing plug proximal portion 1024 and has a thirty-eighth diameter D38 of about 8 mm to about 12 mm, such as about 9 mm to about 11 mm. The outer ridge 1035 is disposed adjacent to the distal annular surface 1033, and more proximal to the proximal end of the third dispensing plug proximal portion 1024 than the distal annular surface 1033. The outer ridge 1035 has a thirty-ninth diameter D39 of about 8 mm to about 12 mm, such as about 9 mm to about 11 mm. In some embodiments, the thirty-ninth diameter D39 of the outer ridge 1035 is greater than the thirty-eighth diameter D38 of the distal annular surface 1033. The sealing wall 1037 includes a first portion 1052, a second portion 1053, and a third portion 1054. The third portion 1054 is at a proximal end of the third dispensing plug proximal portion 1024, the second portion 1053 is disposed between the first portion 1052 and the third portion 1054, and the first portion 1052 is disposed between the second portion 1053 and the outer ridge 1035. The sealing wall 1037 has a fortieth diameter D40 at an interface 1037A of the first portion 1052 and a second portion 1053, a forty-first diameter D41 at an interface 1037B of the second portion 1053 and the third portion 1054, and a forty-second diameter D42 at a proximal region 1037C of the sealing wall 1037. The fortieth diameter D40 is about 8 mm to about 12 mm, such as about 9 mm to about 11 mm, the forty-first diameter D41 of about 7 mm to about 10 mm, such as about 9 mm to about 10 mm, and forty-second diameter D42 of about 8 mm to about 10 mm, such as about 8.5 mm to about 9.5 mm. A tapered interface 1051 is disposed between the first portion 1052 and the outer ridge 1035.

The third dispensing plug proximal portion 1024 has a thirty-fourth height H34 from the distal annular surface 1033 to the proximal region 1037C of the sealing wall 1037, a thirty-fifth height H35 from the distal annular surface 1033 to the interface 1037B of the second portion 1053 and the third portion 1054, and a thirty-sixth height H36 from the distal annular surface 1033 to the interface 1037A of the first portion 1052 and the second portion 1053 of the sealing wall 1037, and a thirty-seventh height H37 from the distal annular surface 1033 to proximal edge of the outer ridge 1035. The thirty-fourth height H34 is about 8 mm to about 12 mm, such as about 9 mm to about 11 mm. The thirty-fifth height H35 is about 7 mm to about 10 mm, such as about 8 mm to about 9 mm. The thirty-sixth height H36 is about 4 mm to about 8 mm, such as about 6 mm to about 7 mm. The thirty-seventh height H37 is about 1 mm to about 4 mm, such as about 2.5 mm to about 3.5 mm.

The annular ridge 1029 is disposed at a distal end of the dispensing plug proximal portion 224 and has a semi-circular shape defined by a sixth circle having a sixth radius R6. The sixth radius R6 is about 0.25 mm to about 1.25 mm, such as about 0.4 mm to about 0.6 mm.

From the proximal end to the distal end of the second dispensing plug proximal portion 924, a fluid flows successively through the inlet channel 940, the tapered channel 938, the flow channel 936, and the retention volume 934. The retention volume 1034 has a thirty-eighth height H38 of about 5 mm to about 8 mm, such as about 6 mm to about 7 mm. The retaining wall 1031 has a thirty-ninth height H39 of about 1 mm to about 3 mm, such as about 1.5 mm to about 2.5 mm. The retainer walls 1031 have a forty-fourth (e.g., outer) diameter D44 and a forty-fifth (e.g., inner) diameter D45 defining the flow channel 936. The forty-fourth diameter D44 is about 5 mm to about 9 mm, such as about 6 mm to about 7 mm. The forty-fifth diameter D45 is about 1 mm to about 4 mm, such as about 2 mm to about 3 mm. In some embodiments, the retention volume 1034 includes an eighth angle Φ8. The eighth angle Φ8 enables a slight expansion of the retention volume 234 from the proximal end of the retention volume 234 to the annular ridge 229. The eighth angle Φ8 is about 90° to about 93°, such as about 91° to about 92°. The tapered channel 238 is defined by a ninth angle Φ9. The ninth angle Φ9 of the tapered channel 238 is about 118° to about 126°, such as about 120° to about 124°. The expansion of the volume between the retaining wall 1031 and the inner surface of the sealing wall 1037 enables the dispensing plug valve 222 to be more easily compression- or friction-fit inside the retention volume 1034. The inlet channel 1040 has a forty-sixth diameter D46 of about 5 mm to about 9 mm, such as about 6 mm to about 7 mm. The third dispensing plug proximal portion 1024 has a fortieth height H40 from the proximal region 1037C of the sealing wall 1037 to the flow channel 1036. The fortieth height H40 is about 1 mm to about 5 mm, such as about 2 mm to about 4 mm.

Generally, the various components of the system 100 can be individually fabricated by any suitable molding techniques, such as by injection molding and/or liquid silicone rubber injection molding, and/or three-dimensional (3D) printing techniques, and thereafter press fit, snap fit, friction fit, or otherwise coupled together during assembly. In some embodiments, however, one or more components of the system 100 can be monolithically molded and/or 3D printed. Similarly, one or more of the components of the flexible container 106 can be fabricated by molding techniques, such as by injection molding and/or liquid silicone rubber injection molding, and/or 3D printing techniques, and thereafter press fit, snap fit, friction fit, or otherwise coupled together during assembly. In some embodiments, however, the flexible container 106 is monolithically molded and/or 3D printed.

Overall, embodiments of the present disclosure provide a system for dispensing fluids (including liquids, gels, solutions, emulsions, suspensions, and the like) from a flexible container. A magnet system, including a two or more magnets, is disposed at a distal end of a dispensing plug valve. The magnet system is retained in position in a retaining region. In addition to a biasing force of the dispensing plug valve, the magnet system enables the dispensing plug valve to be a magnetically controlled one-way valve with an adjustable sealing region, which converts the system into a multi-dose, preservative free medical device. The magnet system prevents microbial ingress from the system exterior by creating a one-way fluid flow that prevents backflow into a flexible container. Magnets of the magnet system are placed on either side of the retaining region to create a magnetic biasing force to prevent backflow into the flexible container. The adjustable sealing region of the magnetically controlled dispensing plug valve can be altered in size so the system can be utilized with a variety of product viscosities while the strength of the magnets can be varied to impact actuation force. The magnetic system can be utilized in a variety of ophthalmic formulations, while being adjustable to meet target product profiles for dosing volume and actuation force.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited in the claims using the phrase “means for” or, in the case of a method claim, the element is recited using the phrase “step for.”

While various examples have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various examples and aspects, it should be understood that the various features and functionality described in one or more of the individual examples are not limited in their applicability to the particular example with which they are described. They instead can be applied, alone or in some combination, to one or more of the other examples of the disclosure, whether or not such examples are described, and whether or not such features are presented as being a part of a described example. Thus the breadth and scope of the present disclosure should not be limited by any of the above-described examples.

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘including’ as used herein is synonymous with ‘including,’ ‘containing,’ or ‘comprising,’ and is inclusive or open-ended and does not exclude additional, unrecited elements or method steps; the term ‘having’ should be interpreted as ‘having at least;’ the term ‘includes’should be interpreted as ‘includes but is not limited to;’ the term ‘example’ is used to provide example instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that some features are critical, essential, or even important to the structure or function of the described subject matter, but instead as merely intended to highlight alternative or additional features that may or may not be utilized in a particular example of the described subject matter. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained.

Furthermore, although the foregoing has been described in some detail by way of illustrations and examples for purposes of clarity and understanding, it is apparent to those skilled in the art that some changes and modifications may be practiced. Therefore, the description and examples should not be construed as limiting the scope of the described subject matter to the specific examples and examples described herein, but rather to also cover all modification and alternatives coming with the true scope and spirit of the described subject matter.

What is claimed is:

1. A dispensing plug valve comprising:
a base at a first end;
a tapered body coupled to the base, wherein the tapered body defines a tapered volume;
a valve tip disposed at a second end;
a retention region disposed between the tapered body and the valve tip;
a magnet system disposed proximate to the valve tip in the retention region, the magnet system comprising a first magnet and a second magnet on opposite sides of the retention region; and
a fluid path defined between the tapered volume and the valve tip within the retention region, wherein fluid exits the valve tip through the fluid path in response to a pressure within the tapered volume overcoming a magnetic biasing force, and wherein fluid is prevented from entering the tapered volume through the fluid path when the pressure within the tapered volume does not overcome the magnetic biasing force.

2. The dispensing plug valve of claim 1, wherein the tapered body comprises a first tapered wall and a second tapered wall, wherein the first tapered wall and the second tapered wall define a tapered angle of about 30° to about 50°.

3. The dispensing plug valve of claim 1, wherein one of the first magnet or the second magnet is a magnetic object.

4. The dispensing plug valve of claim 3, wherein the magnetic object comprises a ferromagnetic material.

5. The dispensing plug valve of claim 4, wherein the dispensing plug valve is formed of an elastic and hydrophobic material.

6. The dispensing plug valve of claim 5, wherein the elastic and hydrophobic material comprises silicone or a thermoplastic elastomer.

7. The dispensing plug valve of claim 1, wherein the dispensing plug valve is a duckbill valve, a flapper valve, or an umbrella valve.

8. A system, comprising:
a flexible container; and
a dispensing plug compression- or friction-fit inside an opening of the flexible container, the dispensing plug comprising:
a dispensing plug distal portion;
a dispensing plug proximal portion; and
a dispensing plug valve disposed between the dispensing plug distal portion and the dispensing plug proximal portion, the dispensing plug valve comprising:
a base at a first end of the dispensing plug valve;
a tapered body coupled to the base, wherein the tapered body defines a tapered volume;
a valve tip disposed at a second end of the dispensing plug valve;
a retention region disposed between the tapered body and the valve tip;
a magnet system disposed proximate to the valve tip and retained in the retention region, the magnet system comprising a first magnet and a second magnet on opposite sides of the retention region; and
a fluid path defined between the tapered volume and the valve tip within the retention region, wherein fluid exits the valve tip through the fluid path in response to exerting a pressure on an outer surface of a body of the flexible container to overcome a magnetic biasing force of the magnet system, and wherein fluid is substantially or completely prevented from entering the tapered volume through the fluid path when the pressure exerted on the outer surface of the body of the flexible container does not overcome the magnetic biasing force.

9. The system of claim 8, wherein the tapered body comprises a first tapered wall and a second tapered wall, wherein the first tapered wall and the second tapered wall define a tapered angle of about 30° to about 50°.

10. The system of claim 8, wherein the dispensing plug valve is comprises an elastic and hydrophobic material.

11. The system of claim 10, wherein the elastic and hydrophobic material comprises silicone or a thermoplastic elastomer.

12. The system of claim 8, wherein the dispensing plug valve is a duckbill valve, a flapper valve, or an umbrella valve.

13. The system of claim 8, wherein the dispensing plug distal portion and dispensing plug proximal portion include a low-density polyethylene (LDPE), a high-density polyethylene (HDPE), a cyclic olefin copolymer (COC), a polyetherimide (PEI), a polytetrafluoroethylene (PTFE), a polyoxymethylene (POM), or combinations thereof.

14. The system of claim 8, wherein one of the first magnet or the second magnet is a magnetic object.

15. The system of claim 14, wherein the magnetic object comprises a ferromagnetic material.
